(19) United States
(12) Patent Application Publication
(10) Pub. No.: US 2003/0151310 A1
(43) Pub. Date: Aug. 14, 2003

(54) Coupling power circuit for information processing device

(76) Inventor: William Yu, Taipei (TW)

Correspondence Address: JACOBSON HOLMAN PLLC, 400 SEVENTH STREET N.W., SUITE 600, WASHINGTON, DC, 20004, US

(21) Appl. No.: 10/073,396

(22) Filed: Feb. 12, 2002

(51) Int. Cl. H02J 1/00

(52) U.S. Cl. 307/75

(57) ABSTRACT

A power circuit applicable to an information-processing device includes coupling circuits for transforming several different voltages. The coupling power circuit includes a driving unit and a transforming unit. When the information-processing device requires several different voltages of power, the driving unit provides a driving signal to the transforming unit. Then, the transforming unit transforms several different voltages through electromagnetic coupling for power output to the information-processing device.

### BACKGROUND OF THE INVENTION

1. Field of the Invention

The invention generally relates to a power circuit for an information-processing device, and particularly relates to a power circuit including coupling circuits.

2. Related Art

With recent technological developments, information-processing devices, such as computers, are increasingly being used in our daily life. The functions of the information-processing devices have increased, and the component blocks of the devices have also increases. An information-processing device generally includes a CPU block, an image processing block, a sound block, a memory block and a power supply block.

Since the power supply has to serve each functional block, in accordance with different voltage and frequency requirements of the blocks, the output of the power supply has to include several different voltages. As shown in FIG. 1, a block diagram of a conventional power circuit 10, the power circuit 10 provides several different voltages V1, V2, V3 of power, for example, 5V, 3.3V, 1.6V, etc., for different functional blocks. Each power output is generated by a driving element 11, 12, or 13 and a switch element 14, 15 or 16 respectively. Theses pairs of components are expensive, occupy the space of the circuit board and cause inconvenience of design.

Therefore, it is necessary to have a simpler power circuit that costs less and is reduced in size.

### SUMMARY OF THE INVENTION

The object of the invention is therefore to provide a power circuit including coupling circuits for transforming several different voltages and reducing the components. The coupling power circuit includes a driving unit and a transforming unit. When the information-processing device requires several different power voltages, the driving unit provides a driving signal to the transforming unit. Then, the transforming unit transforms several different voltages through electromagnetic coupling for power output.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a block diagram of a conventional power circuit;

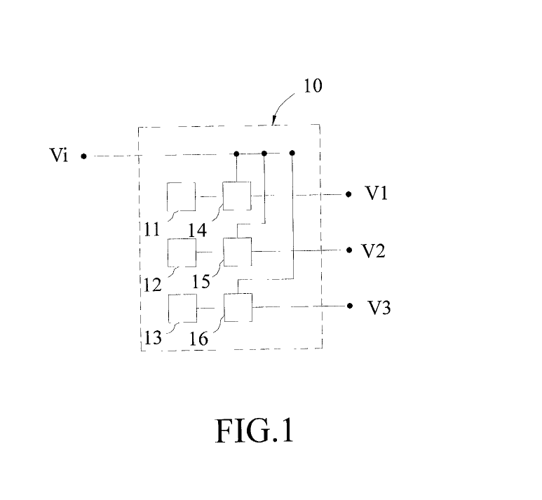

FIG. 2 is a block diagram of a power circuit of the invention; and

FIG. 3 is an explanatory view of a transforming unit in a power circuit of the invention.

### DETAILED DESCRIPTION OF THE INVENTION

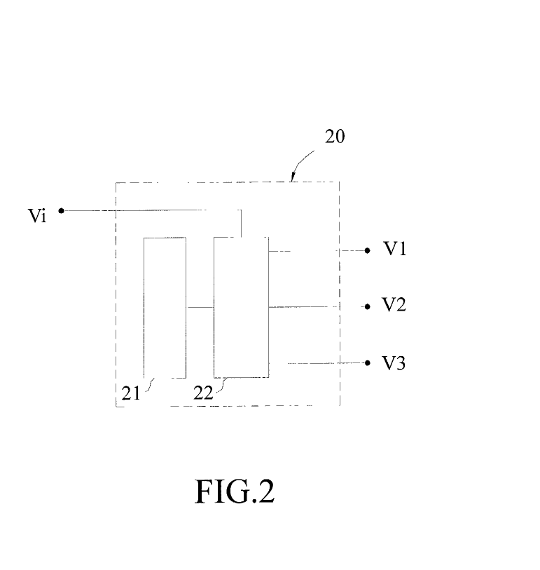

The invention provides a power circuit applicable in a power supply block of an information-processing device. FIG. 2 is a block diagram of the invention. The coupling power circuit utilizes electromagnetic coupling for generating several different voltages of power output. The power circuit 20 includes at least a driving unit 21 and a transforming unit 22. The driving unit 21 can be an driving integrated circuit for generating a driving signal to the transforming unit 22 when the information-processing device is in operation. The transforming unit 22 can be an inductor unit for transforming an input power Vi into a first output voltage V1 (e.g., 5V), a second output voltage V2 (e.g., 3.3V) and a third output voltage V3 (e.g., 1.6V) for the information-processing device to use.

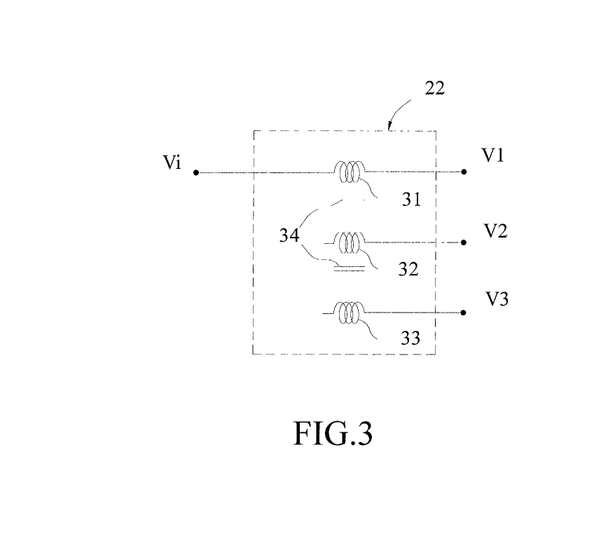

The function of the transforming unit 22 is further illustrated in FIG. 3. The transforming unit 22 includes a first electromagnetic element 31, a second electromagnetic element 32, a third electromagnetic element 33 and several magnetic elements 34. The first electromagnetic element 31 works as a primary coil of induction. An input port of the first electromagnetic element is connected with the input power Vi for transforming the input power Vi into a first output voltage (e.g. 5V) to the output port V1. Meanwhile, the input power Vi is coupled and transferred to the second electromagnetic element 32 as second output voltage. The second electromagnetic element 32 works as a secondary coil of induction. When the first electromagnetic element 31 transduces the electromagnetic field through coupling, the second electromagnetic element 32 induces the second output voltage (e.g. 3.3V) to the output port V2. Meanwhile, the electromagnetic field also induces the third electromagnetic element 33 and transforms the third output voltage (e.g. 1.6V) to the output port V3.

In order to couple the electromagnetic field for inducing power, the transforming unit 22 of the invention includes magnetic elements 34 among the electromagnetic elements 31, 32 and 33. The electromagnetic elements can be transformer coils. Fewer rounds of the coil create a lower voltage, while more rounds create a higher voltage. A larger diameter of the coil wire helps create a larger current output. Usually, the primary coil uses larger diameter wire in order to maintain stable output of the secondary coils.

In conclusion, the invention utilizes an electromagnetic coupling method to transform input power into several output voltages. This power circuit reduces material cost, the size of circuit board, and simplifies the circuit design.The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A coupling power circuit for an information-processing device which is set in a power supply block of the information-processing device, the coupling power circuit comprising:
a driving unit, which is set in the power supply block for generating a driving signal when said information processing device is working; and
a transforming unit, which is connected with said driving unit and an input power for transforming said input power into a plurality of output voltages by coupling of electromagnetic elements.

2. The coupling power circuit of claim 1, wherein said driving unit is an driving integrated circuit (IC).

3. The coupling power circuit of claim 1, wherein said transforming unit is an inductor unit.

4. The coupling power circuit of claim 3, wherein said inductor unit further comprises:
a first electromagnetic element, having an input port connected with said input power for transforming said input power into a first output voltage and transferring an electromagnetic field;
a second electromagnetic element, receiving said electromagnetic field for inducing a second output voltage and transferring said electromagnetic field; and
a third electromagnetic element, receiving said electromagnetic field for inducing a third output voltage.

5. The coupling power circuit of claim 4, wherein said first electromagnetic element is a primary coil.

6. The coupling power circuit of claim 4, wherein said second electromagnetic element is a secondary coil.

7. The coupling power circuit of claim 4, wherein said third electromagnetic element is a secondary coil.

8. The coupling power circuit of claim 4, further comprises a magnetic element mounted between said first and said second electromagnetic elements.

9. The coupling power circuit of claim 4, further comprises a magnetic element mounted between said second and said third electromagnetic elements.
